(19) United States
(12) Patent Application Publication
(10) Pub. No.: US 2013/0325611 A1
(43) Pub. Date: Dec. 5, 2013

(54) METHODS AND SYSTEMS FOR PRE-POPULATING ADVERTISEMENT LANDING PAGES

(71) Applicant: AIRPUSH, INC., Los Angeles, CA (US)

(72) Inventor: Asher Delug, Los Angeles, CA (US)

(73) Assignee: Airpush, Inc., Los Angeles, CA (US)

(21) Appl. No.: 13/804,940

(22) Filed: Mar. 14, 2013

Related U.S. Application Data
(63) Continuation-in-part of application No. 13/623,844, filed on Sep. 20, 2012.
(60) Provisional application No. 61/654,703, filed on Jun. 1, 2012.
(60) Provisional application No. 61/654,802, filed on Jun. 1, 2012.
(60) Provisional application No. 61/672,939, filed on Jul. 18, 2012.
(60) Provisional application No. 61/698,449, filed on Sep. 7, 2012.

(51) Int. Cl. G06Q 30/02

(52) U.S. Cl. CPC G06Q 30/0257; G06Q 30/0267; G06Q 30/0277
USPC 705/14.55

(57) ABSTRACT

Among other disclosed subject matter, a computer-implemented method for pre-populating an online form opened in a mobile device with information from the mobile device, the method includes running, by the mobile device, a mobile application, where the mobile application includes a preconfigured object that is executed when the mobile application is run on the mobile device. The method includes upon receiving, by the mobile application, a selection, by the user, of an advertisement link displayed in the mobile device, the object: (1) identifies a landing page associated with the selected advertisement link displayed in the mobile device; (2) identifies an online form in the identified landing page, the online form including at least one entry field; (3) extracts, from the mobile device, data associated with the user and/or the mobile device for use in filling out the at least one of entry field of the landing page; and (4) utilizes the data extracted from the mobile device, pre-populating the at least one entry field of the landing page. The method includes displaying, by the mobile device, the landing page to the user of the mobile device, where the online form of the landing page is pre-populated using the information extracted from the user's mobile device.

### CLAIM OF PRIORITY

This application is a continuation-in-part of U.S. Nonprovisional application Ser. No. 13/623,844 filed Sep. 20, 2012, which claims priority to U.S. Provisional Application Nos. 61/654,703, filed Jun. 1, 2012, 61/654,802 filed Jun. 1, 2012, 61/672,939, filed Jul. 18, 2012, 61/698,449, filed Sep. 7, 2012, 61/713, 421, filed Oct. 12, 2012, 61/760,952, filed Feb. 5, 2013, all of which are hereby incorporated by reference in their entireties.

### FIELD

The present invention generally relates to information processing. More particularly, the present invention relates to methods and systems for pre-populating advertisement landing pages with user information.

### BACKGROUND

The rapid expansion of the Internet in recent years has led to the rise of internet advertising. Advertisers, content publishers, search engine sites, and advertisement (“ad”) brokers have developed an infrastructure for the delivery of ads referred to as an “ad network.” A content publisher agrees to permit the delivery of ads to specified portions of its content pages as the content pages are viewed by a content consumer. Content consumers include “users” or “subscribers.” Advertisers target such users with ads to market and sell their products. When a user clicks on an ad, offered either through a content publisher's web page or through the user's mobile phone, the user is directed to a landing page. The landing page is the page the advertiser wishes to display to the user.

In some instances, the landing page includes one or more user sections (i.e., online forms) where the user fills in the user's personal information. Some of the commonly filled out forms include forms filled out for purchasing products relating to the clicked advertisement, forms for requesting information relating to the clicked advertisement campaign, forms for submitting questions relating to the product on the clicked advertisement, etc. Users might repeatedly be required to enter the same information including their name, home address, business address, email address, and/or phone numbers on a variety of different forms.

For example, a landing page may include information about a product or service the advertiser wishes to sell and may present the user with one or more sections for the user to fill in the user's personal information. Also, the landing page may include sections allowing the user to provide e-mail or physical mailing address information to allow the address to send sales brochures or additional information about the user's product. In some instances, the landing page may include sections to request the user to provide information about certain user preferences such as the user's primary zip location or area-code information for searching restaurants or sporting good stores.

In order for the advertisement to achieve its intended purpose, the advertiser needs to simplify the inputs needed from the user to achieve that intended purpose. For example, when an advertisement links a landing page with a purchase form for the product advertised, the user likely intends to purchase the advertised product when the user clicks on the advertisement. By automatically filing out any of the necessary information in the purchase form, the advertiser reduces the user effort needed to complete the purchase and in turn increases the likelihood the user will complete the purchase.

Unfortunately, conventional methods which have attempted to address these concerns are problematic. For example, under one conventional method, the user fills out the information manually every time he encounters the landing page. In another conventional method, the user's web browser locally provides the user's personal information and pre-populates the user's personal information. However, in the first conventional method, the user is forced to type out the information every time he encounters a landing page, which is laborious. In the second conventional method, the user entrusts personal information (which may include personal information and credit information) to a web browser and does not discriminate forms where the user wishes the information to be pre-filled and places where the user does not wish information to be pre-populated.

Other traditional methods may provide automated input of some data, however, these methods may still be deficient and therefore, unable to meet the many needs of today's Internet user.

Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE DESCRIPTION

The invention relates to pre-populating an online form with information gathered from a computing device.

In a first aspect, a computer-implemented method for pre-populating an online form opened in a mobile device with information from the mobile device. The method includes running, by the mobile device, a mobile application, where the mobile application includes a preconfigured object that is executed when the mobile application is run on the mobile device. The method further includes upon receiving, by the mobile application, a selection, by the user, of an advertisement link displayed in the mobile device, the object: (1) identifies a landing page associated with the selected advertisement link displayed in the mobile device; (2) identifies an online form in the identified landing page, the online form including at least one entry field; (3) extracts, from the mobile device, data associated with the user and/or the mobile device for use in filling out the at least one of entry field of the landing page; and (4) utilizes the data extracted from the mobile device to pre-populate at least one entry field of the landing page. The method includes displaying, by the mobile device, the landing page to the user of the mobile device, where the online form of the landing page is pre-populated using the information extracted from the mobile device.

Implementations can include any, all or none of the following features. The method can further include modifying configuration of the object to disable pre-populating a given online form, where the modification of the object's configuration can be performed by one or more of: (1) a given user of the mobile device; (2) a developer of the mobile application; or (3) a provider of the preconfigured object. The method can further include requesting, by the mobile device, the user of the mobile device, permission to access the mobile device for extracting the data associated with the user and/or the given mobile device. The method can further include storing, by the mobile device executing the preconfigured object, the data gathered for the one or more identified fields in a user account associated with the user of the mobile device. The method can further include utilizing, by the mobile device, the stored data to pre-populate a one or more identified fields in a second identified online form present in a second identified landing page, where the second identified landing page is associated with a second presented advertisement link, and further where the second presented advertisement link is opened at a later time after the opening of the first presented advertisement link.

The method can further include purging, by the mobile device, the extracted data subsequent to one or more of: (1) receiving a request from a user to delete the information; (2) subsequent to a specified duration of time; (3) subsequent to usage of the extracted information in a specified number of landing pages; or (4) subsequent to usage of the extracted information at the landing page. The method can further include, when requesting, by the mobile device, for permission of the user of the mobile device to gather data for the one or more identified fields: (1) providing, by the mobile device, the user with a list of one or more identified fields which the mobile device identified to gather data for; and (2) receiving, by the mobile device, a selection of one or more identified fields from the list by the user, where the selection of one or more identified fields by the user provides the mobile device permission of the user to gather data for the selected fields.

In a second aspect, a computer-implemented method for pre-populating an online form, the method includes receiving, by computing server, an indication, from a user of a given computing device, of a user desire to access a first link included in a first webpage displayed to the user via the given computing device. The method further includes identifying, by the computing server, a landing page associated with the first link identified by the user. The method further includes identifying, by the computing server, presence of one or more fields in the landing page configured to receive data entered by the user. The method further includes dynamically extracting, by the computing server, data associated with the user and/or the given computing device from the given computing device. The method further includes receiving, by the computing server, an indication of display of the landing page associated with the first link at the given computing device. The method further includes, utilizing the data extracted from the given computing device, pre-populating, by the computing server, at least one of the one or more identified fields in the landing page displayed by the given computing device.

Implementations can include any, all or none of the following features. The method can further include requesting, by the computing server, from the user of the computing device, permission to access the computing device for extracting the data associated with the user and/or the given computing device. The method can further include storing, by the computing server, the data gathered for the one or more identified fields in a user account associated with the user of the computing device. The method can further include utilizing, by the computing server, the stored data to pre-populate a one or more identified fields in a second online form present in a second landing page. In some instances, the second landing page is associated with a second advertisement link, and the second advertisement link is opened at a later time after the opening of the first advertisement link. The method can further include purging, by the computing server, the extracted data subsequent to one or more of: (1) receiving a request from a user to delete the information; (2) subsequent to a specified duration of time; (3) subsequent to usage of the extracted information in a specified number of landing pages; or (4) subsequent to usage of the extracted information at the landing page.

Implementations can include any, all or none of the following features. Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 and the following discussion provide a brief, general description of a representative environment in which the invention can be implemented;

FIGS. 2A, 2B, and 2C illustrate the pre-population of advertisement landing pages by an advertisement server;

FIG. 3 is a block diagram illustrating an exemplary architecture of an advertisement server and mobile device configured to perform the various functionalities discussed in FIGS. 1, 2 and 5;

FIG. 4 is a flow diagram depicting a process 400 for providing the advertising service described herein;

FIG. 5 illustrate the pre-population of advertisement landing pages by a computing device such as mobile phones; and

FIG. 6 is a high-level block diagram showing an example of the architecture for a computer system.

The headings provided herein are for convenience only and do not necessarily affect the scope or meaning of the claimed invention.

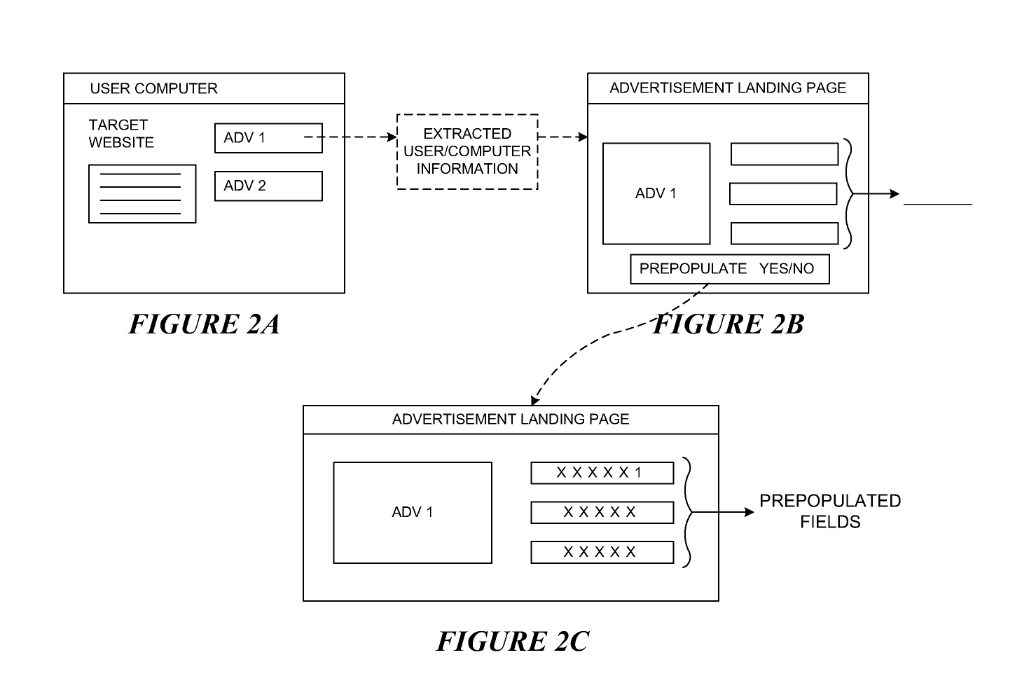

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

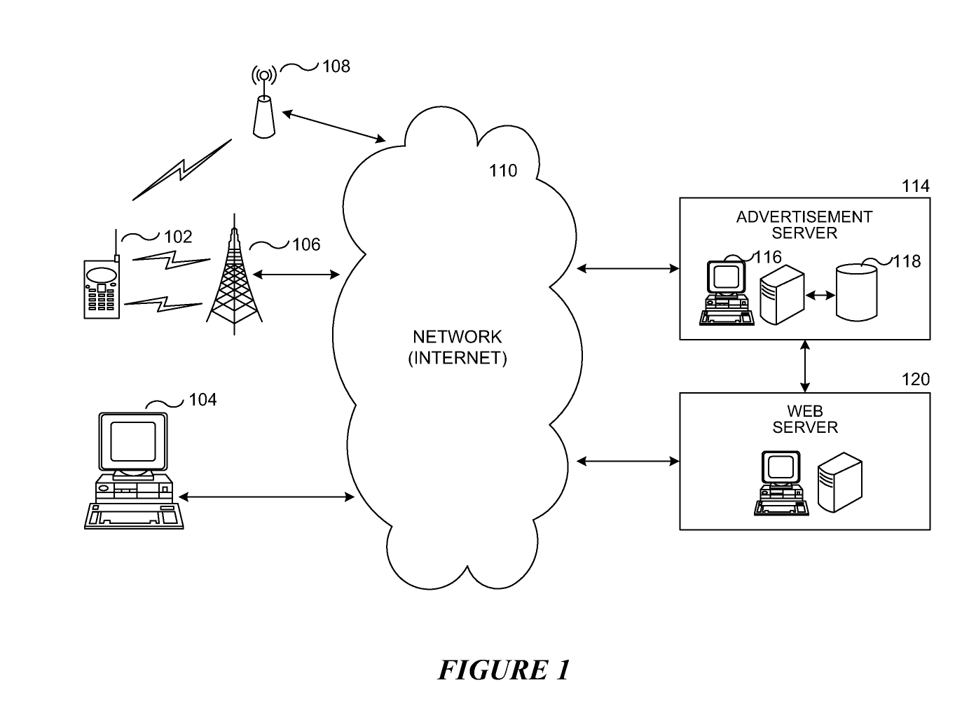

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 102, the personal computer 104, etc.) to connect to one or more web pages through the network 110. In one embodiment, the user's request to access to a given web page directs the user to, for example, a web server 120 that operates and provides access to the web page requested by the user.

In some instances, a content publisher, such as a website publisher, can agree to permit the delivery of ads to specified portions of its web pages as the web pages are viewed by a content consumer. Content consumers could include the website users. An advertiser could compensate the content publisher for the use of a portion of a content page of the web page to display the advertiser's ad. Ad brokers may insert themselves in the middle of the transaction by facilitating the delivery of high-value ad content and receiving a portion of the ad revenues.

In some instances, a user may enter “Bahamas” into a website's search engine search field to obtain information about travel to the Bahamas. The web server 120 executing the search engine may return a list of uniform resource locators related to the Bahamas. The user may click on one of the URLs related to travel in the Bahamas. The user's web browser may send an HTTP request for the desired URL to the selected website (the “content provider”). The web server 120 hosting the website with web pages may then return one or more HTTP response messages containing the page content.

In one embodiment, the web server 120 communicates with an advertisement server 114 to provide one or more advertisements in conjunction with web pages offered by the web server 120. The web pages in the website may be embedded with an ad “slot” in one or more of the responses. The ad slot effectively reserves a blank space on the web page as displayed to the user for subsequent insertion of an ad. In some instances, the advertisement server 114 may communicate with one or more advertising agencies or other such sources of advertisements to coordinate placement of online advertisements in a variety of web pages (e.g., in the web pages displayed by the web server 120).

In some instances, the user's web browser may send a request message back to the content provider to request the ad. The content provider may then send a response message back to the user with the ad appended or may forward the user ad request to the advertisement server 114 for fulfillment of the ad. In some instances, the advertisement server 114 is maintained by an ad broker or an advertising entity itself.

In some instances, the advertisement server 114 may also operate an inherent web server to also provide web pages requested by the user. It is understood that the exact configuration and division of web and advertising services, as discussed above, is for the purpose of an exemplary illustration. Other examples of offering connectivity to user-requested web pages and cross-linked advertisements, as understood by a person of ordinary skill in the art, are equivalent variants of the techniques illustrated herein.

In some instances, for example, the advertisements supplied by the advertisement server 114 to the web pages displayed to the user are displayed within web widgets included in the web pages. In some instances, the advertisements are displayed in the form of banner ads in a specified section of the web pages. Other examples, as understood by a person of ordinary skill in the art, may also be used as equivalent variants used in conjunction with the techniques discussed herein.

In some instances, a content publisher, such as a mobile application developer, can agree to permit the delivery of ads to specified portions of the mobile application's content pages as the content pages are viewed by a content consumer. Content consumers could include the mobile phone users. An advertiser could compensate the content publisher for the use of a portion of a content page of the mobile application to display the advertiser's ad.

In some instances, a user may run a mobile application, such as “Weather Report” that provides the user with the latest weather report in a given location, on their mobile phone 102. When run by the user, the mobile application may query a web server 120 to retrieve the latest weather report in a given location. Further, the mobile application may communicate with the web server 120 to request for an ad to be placed within the content pages of the requested weather report. In some instances, the mobile application may communicate with the web server 120 to request for an ad to be placed interleaved between content pages of the requested weather report. Further, in some instances, the mobile application may communicate with the web server 120 to request for an ad to be placed in the notification tray of the mobile phone 102, which is outside the content pages provided by the mobile application.

In some instances, the web server 120 may communicate with the advertisement server 114 to provide one or more advertisements in conjunction with content pages offered by the web server 120 through the mobile application. The content pages in the mobile application may be embedded with an ad “slot” in one or more of the responses. The ad slot effectively reserves a blank space on the content page as displayed to the user for subsequent insertion of an ad. In some instances, the advertisement server 114 may communicate with one or more advertising agencies or other such sources of advertisements to coordinate placement of online advertisements in a variety of content pages (e.g., in between the pages of the weather report provided by the mobile application).

In some instances, the user's mobile application may send a request message back to the content provider to request the ad. The content provider may then send a response message back to the user with the ad appended or may forward the user ad request to the advertisement server 114 for fulfillment of the ad. In some instances, the advertisement server 114 is maintained by an ad broker or an advertising entity itself.

In some instances, for example, the advertisements supplied by the advertisement server 114 to the content pages displayed to the mobile user are displayed within widgets included in the content pages of the mobile application. In some instances, the advertisements are displayed in the form of banner ads in a specified section of the content pages. In some instances, the advertisements are displayed in the mobile phone's 102 notification tray, where the advertisements will be accessible to the mobile phone user outside the mobile application. Other examples, as understood by a person of ordinary skill in the art, may also be used as equivalent variants used in conjunction with the techniques discussed herein.

The advertisements may be of any form as is understood in the industry. For example, the advertisements may be branding ads, where a video or a loop of videos or other multimedia data is played in the specified section of the web page. Clicking on the multimedia section at any point would direct the user to a “landing page” associated with the advertiser where the user may be presented with additional information. In some examples, the advertisement may simply be a link to the landing page. In other examples, the advertisement may be a banner that links the user to the advertiser's landing page. In some examples, the landing page may itself be displayed within the advertising section of the user's web page. In other examples, the landing page may be a new page that is opened in response to the user's clicking the advertising section.

For purpose of further illustration, it is useful to consider the techniques explained herein as it applies to advertising pages. Of course, however, it should be noted that the techniques introduced here extend to other types of situations where a user's personal information is transported from the user's computer to a different landing page where the user's information may be pre-populated.

An illustration of the above example of web pages and advertising landing pages is discussed in relation to FIGS. 2A to 2C. FIG. 2A illustrates a web page displayed in a user's computer (e.g., 104). The web page includes the content (e.g., news, shopping web site, etc.) that the user originally requested and was provided by, for example, the web server 120. As discussed above, the web page may also include one or more advertisements (e.g., ADV 1, ADV 2, etc.) in banners or web widgets or the like.

In normal scenarios, when the user clicks on or selects one of the advertisements, the user is directed to a landing page (the page illustrated in FIG. 2C). The landing page is the page the advertiser wishes to display to the user. In some instances, the landing page includes one or more user sections where the user fills in personal information. For example, the landing page may include information about a product or service the advertiser wishes to sell and may present the user with one or more sections for the user to fill in the user's personal information. For example, the landing page may include sections allowing the user to provide e-mail or physical mailing address information to allow the address to send sales brochures or additional information about the user's product. In some instances, the landing page may include sections to request the user to provide information about certain user preferences such as the user's primary zip location or area-code information for searching restaurants or sporting good stores.

In normal scenarios, the user fills out the information manually every time he encounters the landing page. In other instances, the user's web browser locally (or at a server associated with the web browser) provides the user's personal information and pre-populates the user's personal information. However, in the first normal scenario, the user is forced to type out the information every time he encounters a landing page, which is laborious. In the second scenario, the user entrusts personal information (which may include personal information and credit information) to a web browser and does not discriminate forms where the user wishes the information to be pre-filled and places where the user does not wish information to be pre-populated.

The techniques introduced herein operate in a different manner to enable the user to have pre-filled information on landing pages. Here, in some instances, the advertising server provides ads embedded with preconfigured object files, such as software routines, which when activated can perform a variety of tasks. Here, in some instances, when the user clicks on the advertisement links on the web page, the advertising server receiving information about this request activates software routines embedded within the clicked ad. The software routines then extract personal information about the user from the user's computer.

In some instances, the software routines embedded within the clicked ad can automatically extract personal information about the user from the user's computer when activated by a user's click. For example, SDK routines (e.g., API links) initiated by the click on the advertising link cause the information to be extracted from the user's computer and then sent to the advertisement server 114. In some instances, the advertisement server 114 parses the landing page associated with an advertisement served to the user's computer to identify fields in any online forms associated with the landing page. The advertisement server 114 could provide the software routines embedded within the clicked ad with information regarding the identified fields before the ad is placed in the user's computer. When activated by a user's click of the ad, the embedded software routines can automatically extract personal information about the user from the user's computer pertaining to the identified fields embedded within the routines

In another instance, the user's computer could be running applications embedded with pre-configured object files. When such applications are used by the advertisement server to display ads, the pre-configured object file can monitor the ads and automatically extract personal information about the user from the user's computer when the user clicks the advertisement. In some instances, the user's computer could be running an operating system that manages the computer resources and data information present in the user's computer. The advertisement server 114 can extract data from the user's computer by querying the operating system of the user's computer for information pertaining to the identified fields.

In some instances, the extracted information is then conveyed from the user's computer to the advertisement server 114, which in turn forwards the extracted information to the ensuing landing page (see FIG. 2C). The landing page then parses the user's information and causes the information to be pre-populated in relevant sections in the landing page. In some instances, the pre-configured object file running on the user's computer identifies the fields in the online form and determines the information needed to be filled in the fields available in the online form. The pre-configured object file could then extract the available information from the user's computer and pre-populate the information in the landing page.

In one embodiment, the advertisement server 114 causes the information to be retrieved from one or more of a variety of locations of the user's personal computer. In embodiments, the information is extracted dynamically from the user's personal computer. Dynamic extraction has several advantages. The information is not stored by the advertisement server 114 permanently, minimizing loss or misappropriation of the data. The extracted data is used for the purpose of filling out the forms and then discarded, enhancing data security. In some instances, the information may be extracted once by the advertising server and stored in conjunction with the user's account, such that the information may simply be used in any landing page (without dynamic extraction) for any future landing pages. Of course, in such instances, the advertising server may still extract additional personal information during each click if new or updated personal information is identified.

The personal information may be extracted, for example, from the user's mail account where the user self-identifies his personal information, or in other places of the user's personal computer as may be contemplated by a person of ordinary skill in the art. Further the information that is retrieved may be parsed to identify specific types of information using techniques that may be contemplated by a person of ordinary skill in the art.

In some instances, as illustrated in FIG. 2B, when the user clicks on the advertisement (and prior to taking the user to the landing page), the advertisement server 114 may cause, for example, a window or a new intermediary window to be opened to request the user to confirm or agree to the information being extracted from the user's computer and used in the landing page. In some instances, the information may directly be applied to the landing page and have the information sections auto populated and auto-submitted. In some instances, the user has the further ability to accept or edit the information that is pre-populated in the landing page.

In some instances, as discussed above, the advertisement server 114 may retain the information extracted from the user's computer 104 in association with, for example, a user account associated with the user or a cookie associated with the user's computer and use the information for future pre-population of landing pages users may end at. In some instances, the user may be provided options as to allowing the advertising server to selectively retain some information (e.g., user's address, etc.) while discarding or purging the other data (e.g., financial or credit information) after it is used in pre-populating the current landing page.

In some instances, the advertising server may selectively send, for example, non-confidential information back to the advertiser (prior to the landing page being displayed) allowing the advertiser to customize the landing page based on the information in addition to pre-populating the ensuing page. For example, the advertisement server 114 may relate to the advertiser that the user is from California or from San Francisco (without revealing the user's actual address) allowing the advertiser to customize the landing page in a fashion that is appealing to a Californian resident. Other examples, as may be contemplated by a person of ordinary skill in the art, may also be used in conjunction with the techniques discussed above.

In some instances, the advertisement server 114 may first identify what type of information needs to be pre-populated in the ensuing landing page and accordingly minimize extraction of personal information from the user's computer. This prevents unnecessary information from being extracted from the user's computer, thus further enhancing a user's privacy while providing him with the benefits of the auto-population in the landing page. In some instances, the user may specify or limit the types of personal information that may be extracted from the user's computer, thus limiting the information extracted to suit the user's preferences.

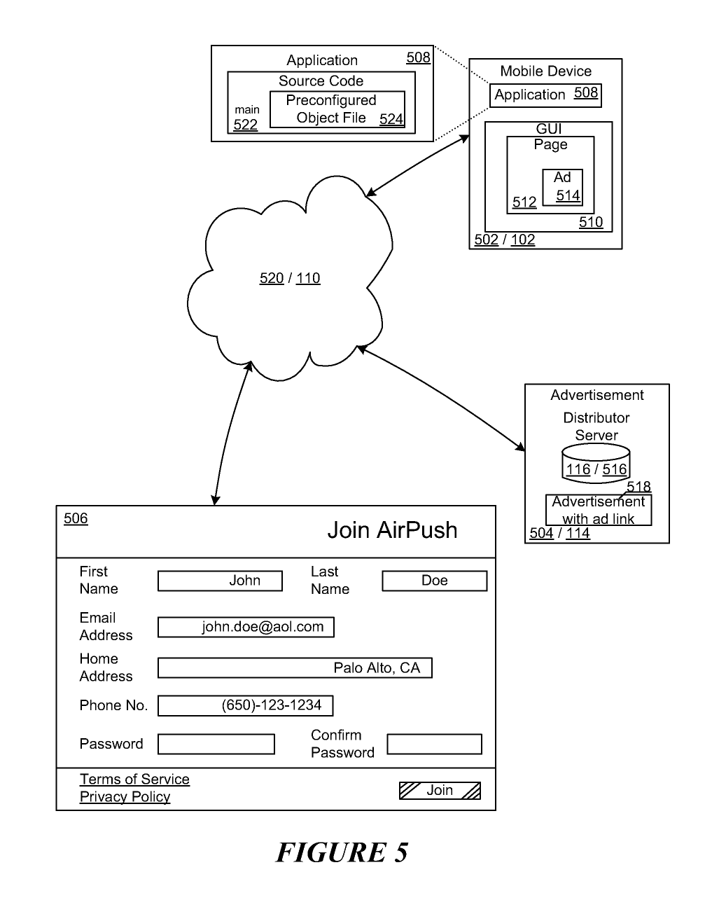

Another illustration of the above example of advertising in mobile devices and pre-populating associated advertising landing pages is discussed in relation to FIG. 5. FIG. 5 illustrates a mobile application displayed in a user's mobile device (e.g., 502). The mobile application includes the content (e.g., news, shopping, games, banking, weather report, etc.) that the user originally requested and was provided by, for example, the mobile device 502. As discussed above, the mobile application may also serve one or more advertisements (e.g., ADV 1, ADV 2, etc.) in banners or widgets or the like.

In one embodiment, the mobile application developer can embed a preconfigured object file 524, e.g., JAR file, within their application's source code 522. When the application's source code 522 is compiled, the preconfigured object file 524 becomes part of the mobile application 508. In some instances, the preconfigured object file 524 can be placed within the mobile application's main( ) function, ensuring the execution of preconfigured object file 524 when the mobile application 508 is run by the user.

In another embodiment, when the mobile application 508 containing the preconfigured object file 524 is executed, the preconfigured object file 524 is also executed once from the main activity of a mobile application 508. When executing, the preconfigured object file 524 utilizes the mobile device's operating system framework to schedule ongoing polling events of the advertisement server 504 a few times per day, where each polling event runs briefly as a background service. In some instances, the network 520 is the Internet, allowing the mobile device 502 (with, for example, WiFi capability) to communicate with the advertisement server 504.

In one embodiment, the advertisement server 504 could be a cluster of linux-based ad servers 516, where the ad servers determine the optimal ads to delivered in response to polling from clients. In some instances, the advertisement server 504 serves ads that are embedded with advertisement links 518, such as a HTTP link to a web page within a website, which the user of the mobile device 502 can access by clicking on the ad with the embedded advertisement links 518.

In some instances, the advertisement server 504 determines the ads to be placed based on a combination of bid from advertisers and relevance of the ad to the user. In some instances, the advertisement server 504 determines the ad's relevance to user based on factors such as information about the target mobile application 502 the ad is placed in, etc.

In some instances, the preconfigured object file 524 requests (i.e., polls) for an ad from the advertisement server 504 and cache any received ads from the advertisement server 504 until optimal display time. In some instances, the preconfigured object file 524 can schedule a display of a received ad 514 interleaved between the content page 512 of the mobile application. The content page 512 of the mobile application can be made viewable through the graphical user interface 510 (“GUI”) of the mobile device 502. In another instance, the preconfigured object file 524 can schedule a display of the received ad 514 within a specified portion of the content page 512 as the content page is viewed by the mobile device 502 user. In another instance, the preconfigured object file 524 can schedule a display of the received ad 514 in the user notification tray of the mobile device 502, where the received ad 514 can be viewed by the user outside of the content page 512 of the mobile application 508.

In one embodiment, the preconfigured object file 524 could schedule a display of a received ad 514 with an embedded advertisement link 518. When a user of the mobile device 502 clicks on an embedded advertisement link 518 within an ad, the user is directed to a landing page 506. The landing page 506 is the page the advertiser wishes to display to the user. For example, the landing page 506 could be a web page with information relating to the ad 514 displayed on the mobile device 502.

In some instances, the landing page 506 includes one or more user sections where the user fills in personal information. For example, the landing page 506 may include information about a product or service the advertiser wishes to sell and may present the user with one or more sections for the user to fill in the user's personal information. For example, the landing page 506 may include sections allowing the user to provide e-mail or physical mailing address information to allow the address to send sales brochures or additional information about the user's product. In some instances, the landing page 506 may include sections to request the user to provide information about certain user preferences such as the user's primary zip location or area-code information for searching restaurants or sporting good stores.

In normal scenarios, the user fills out the information manually every time he encounters the landing page 506. The techniques introduced herein operate in a different manner to enable the user to have pre-filled information on landing page 506. Here, in some instances, the preconfigured object file 524 requests advertisement server 504 to provide ads with embedded executable files, such as software routines, which when activated perform a variety of tasks. Here, in some instances, when the user clicks on the ad with the embedded executable file and the embedded advertisement link 518, the mobile device opens the landing page 506 associated with the embedded advertisement link 518 while executing the software routine embedded within the clicked ad. The software routine automatically extracts information from the user's mobile device needed by the forms in the landing page 506.

In another instance, the pre-configured object file 524 could track advertisements placed by the advertisement server 504. For example, when a mobile application 508 with the pre-configured object file 524 is used by the advertisement server to display ads, the pre-configured object file can monitor the advertisements placed through the mobile application. When a user clicks such a monitored advertisement to open an embedded advertisement link 518, the pre-configured object file 524 could automatically extract information from the user's mobile device needed to pre-populate forms in landing page 506 associated with the embedded advertisement link 518.

In some instances, the extracted information is then conveyed from the user's mobile device to the advertisement server 504, which in turn forwards the extracted information to the ensuing landing page 506 (see FIG. 2C). The landing page 506 then parses the user's information and causes the information to be pre-populated in relevant sections in the landing page 506. In some instances, the pre-configured object file running on the user's mobile device identifies the fields in the online form and determines the information needed to be filled in the fields available in the online form. The pre-configured object file could then extract the available information from the user's mobile device and pre-populate the information in the landing page 506.

In one embodiment, the information from the mobile device may be retrieved from one or more of a variety of locations through the user's mobile device. In embodiments, the information is extracted dynamically from the user's mobile device. Dynamic extraction has several advantages. The information may not stored by the any web browser permanently, minimizing loss or misappropriation of the data. The extracted data could be used for the purpose of filling out the forms and then discarded, enhancing data security. In some instances, the information may be extracted once by the pre-configured object file 524 or the executable file embedded within the received ad 514 and stored in conjunction with the user's account, such that the information may simply be used in any landing page 506 (without dynamic extraction) for any future landing page 506. Of course, in such instances, the advertising server may still extract additional personal information during each click if new or updated personal information is identified.

The personal information may be extracted, for example, from the user's mail account where the user self-identifies his personal information, or in other places of the user's mobile device as may be contemplated by a person of ordinary skill in the art. Further the information that is retrieved may be parsed to identify specific types of information using techniques that may be contemplated by a person of ordinary skill in the art.

In some instances, as illustrated in FIG. 2B, when the user clicks on the advertisement (and prior to taking the user to the landing page 506), the preconfigured object file 524 or the executable file embedded in the received ad 512 may cause, for example, a window or a new intermediary window to be opened. The window could be used to request the user to confirm or agree to the information being extracted from the user's mobile device and used in the landing page 506. In some instances, the information may directly be applied to the landing page 506 and have the information sections auto populated and auto-submitted. In some instances, the user has the further ability to accept or edit the information that is pre-populated in the landing page 506.

In some instances, as discussed above, the preconfigured object file 524 or the executable file embedded in the received ad 512 may retain the information extracted from the user's mobile device 502 in association with, for example, a user account associated with the user or a cookie associated with the user's computer and use the information for future pre-population of landing page 506s users may end at. In some instances, the user may be provided options as to allowing the advertising server to selectively retain some information (e.g., user's address, etc.) while discarding or purging the other data (e.g., financial or credit information) after it is used in pre-populating the current landing page 506.

In some instances, the preconfigured object file 524 or the executable file embedded in the received ad 512 may selectively send, for example, non-confidential information back to the advertiser (prior to the landing page 506 being displayed) allowing the advertiser to customize the landing page 506 based on the information in addition to pre-populating the ensuing page. For example, the preconfigured object file 524 or the executable file embedded in the received ad 512 may relate to the advertiser that the user is from California or from San Francisco (without revealing the user's actual address) allowing the advertiser to customize the landing page 506 in a fashion that is appealing to a Californian resident. Other examples, as may be contemplated by a person of ordinary skill in the art, may also be used in conjunction with the techniques discussed above.

In some instances, the preconfigured object file 524 or the executable file embedded in the received ad 512 may first identify what type of information needs to be pre-populated in the ensuing landing page 506 and accordingly minimize extraction of personal information from the user's computer. This prevents unnecessary information from being extracted from the user's computer, thus further enhancing a user's privacy while providing him with the benefits of the auto-population in the landing page 506. In some instances, the user may specify or limit the types of personal information that may be extracted from the user's computer, thus limiting the information extracted to suit the user's preferences.

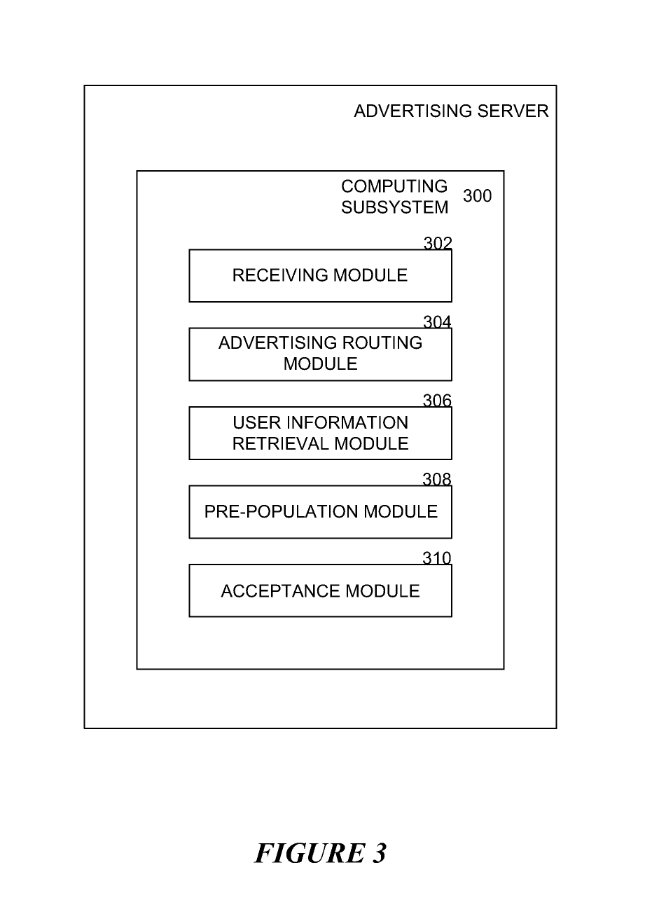

FIG. 3 is a block diagram illustrating an exemplary architecture of an advertisement server 114 configured to perform the various functionalities discussed herein. In the illustrated embodiment, the advertisement server 114 includes a computing subsystem 300, which performs various functions related to the advertisement service. The computing subsystem 300 can be implemented by using programmable circuitry programmed by software and/or firmware, or by using special-purpose hardwired circuitry, or by using a combination of such embodiments. In some instances, the computing subsystem 300 is implemented as a unit in a processor of the advertisement server.

In some instances, the computing subsystem 300 includes a receiving module 302 to receive indications of a user's click of an advertisement hosted via the advertisement server 114. Upon receiving the information using, for example, API calls, the receiving module initiates routines to extract additional user information as discussed above. An advertisement routing module 304 then directs the user to a landing page. In some instances, and as suitable for a particular method of advertising used, the advertising routing module may initiate communication with and retrieve landing page information. A user information retrieval module 306 is then responsible for extracting relevant user information from the user's computer using one or more of the techniques discussed herein. A pre-population module 308 uses the extracted information selectively or completely for pre-populating various sections in the landing page. A user customization module 310 is responsible for providing options to the user to select particular types of information for pre-population or to even select the option of pre-populating the landing page.

In another embodiment, the block diagram in FIG. 3 illustrates an exemplary architecture of a mobile device 102 configured to perform the various functionalities discussed herein. In the illustrated embodiment, the mobile device 102 includes a computing subsystem 300, which performs various functions related to the pre-population of online forms. The computing subsystem 300 can be implemented by using programmable circuitry programmed by software and/or firmware, or by using special-purpose hardwired circuitry, or by using a combination of such embodiments. In some instances, the computing subsystem 300 is implemented as a unit in a processor of the mobile device.

In some instances, the computing subsystem 300 includes a computing module for running a mobile application, where the mobile application could include a preconfigured object that is executed when the mobile application is running on the mobile device. The computation subsystem 300 includes a receiving module 302 to receive indications of a user's click of an advertisement hosted via the advertisement server 704. Upon receiving the information using, for example, API calls, the receiving module forwards the indication of the user's click of the advertisement to the object being executed on the computing module.

The object, running on the computing module, initiates routines to extract additional user information as discussed above. In some instances, the object communicates with an advertisement routing module 304 to direct the user to a landing page. In some instances, and as suitable for a particular method of advertising used, the advertising routing module may initiate communication with and retrieve landing page information. In another instance, the object a user information retrieval module 306 for extracting relevant user information from the user's mobile device using one or more of the techniques discussed herein. In some instances, a pre-population module 308 uses the extracted information selectively or completely for pre-populating various sections in the landing page. In another instance, a user customization module 310 is responsible for providing options to the user to select particular types of information for pre-population or to even select the option of pre-populating the landing page.

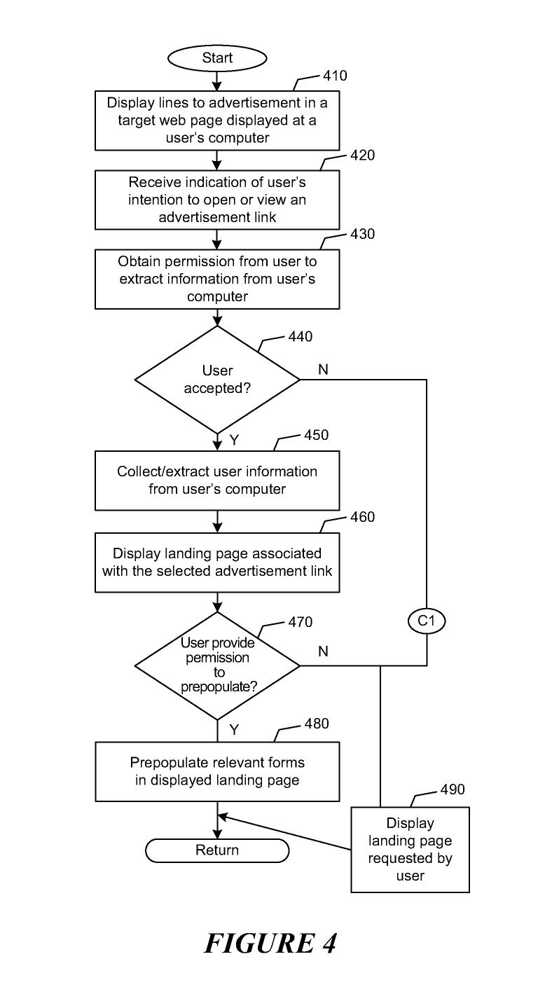

FIG. 4 is a flow diagram depicting a process 400 for providing the advertising service described herein. It is understood that this is one embodiment of an illustrative method, and that other variations to the method, in accordance with various techniques discussed above in this document or in accordance with variations contemplated by persons of ordinary skill in the art, are also included herein. As indicated in block 410, the process 400 causes advertisements to be placed in a web page requested by the user. At block 420, the process 400 receives an indication of a user having clicked an advertisement. At block 430, the process 400 collects the user's personal information. In some instances, this may be an optional step after the user accepts extraction of such information. At block 440, the process optionally 400 queries whether the user wants this information transmitted to the advertising server or to the landing page for use in pre-population. When the user agrees, the process 400 transfer to block 450, where the user information is collected. At block 460, the landing page is displayed to the user in response to the user's clicking on the advertisement. At block 470, the process 400 optionally queries whether the user would like the information extracted from the user's computer to be pre-populated in the landing page. Optionally, at block 470, the process 400 may verify or confirm which information may be used for pre-population, for saving in association with the user's account, purging, etc. Based on this information, at block 480, the process 400 uses the extracted information to pre-populate the landing page.

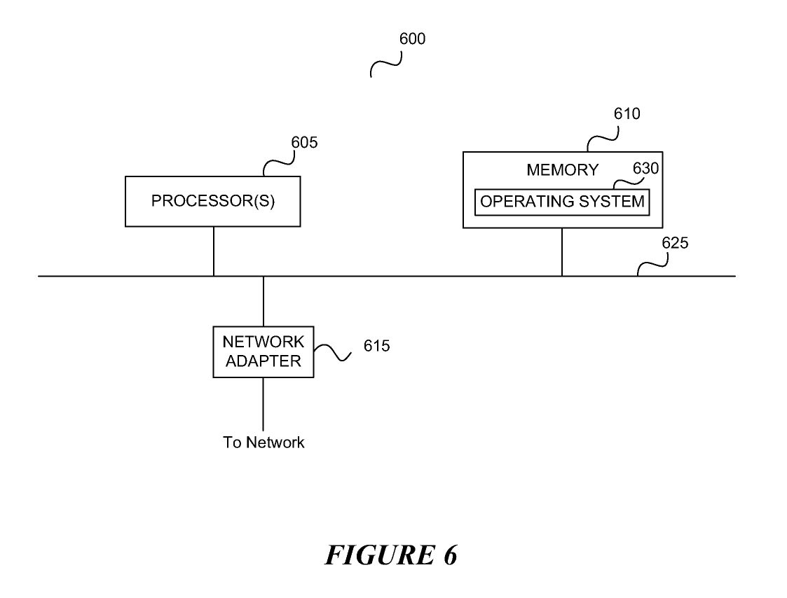

FIG. 6 is a high-level block diagram showing an example of the architecture for a computer system 600 that can be utilized to implement a advertisement server (e.g., 114 from FIG. 1), a web server (e.g., 125 from FIG. 1), etc. In FIG. 6, the computer system 600 includes one or more processors 605 and memory 610 connected via an interconnect 625. The interconnect 625 is an abstraction that represents any one or more separate physical buses, point to point connections, or both connected by appropriate bridges, adapters, or controllers. The interconnect 625, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The processor(s) 605 may include central processing units (CPUs) to control the overall operation of, for example, the host computer. In certain embodiments, the processor(s) 605 accomplish this by executing software or firmware stored in memory 610. The processor(s) 605 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 610 is or includes the main memory of the computer system 1100. The memory 610 represents any form of random access memory (RAM), read-only memory (ROM), flash memory (as discussed above), or the like, or a combination of such devices. In use, the memory 610 may contain, among other things, a set of machine instructions which, when executed by processor 605, causes the processor 605 to perform operations to implement embodiments of the present invention.

Also connected to the processor(s) 605 through the interconnect 625 is a network adapter 615. The network adapter 615 provides the computer system 600 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A computer-implemented method for pre-populating an online form opened in a mobile device with information from the mobile device, the method comprising:
running, by the mobile device, a mobile application, wherein the mobile application includes a preconfigured object that is executed when the mobile application is run on the mobile device;
upon receiving, by the mobile application, a selection, by the user, of an advertisement link displayed in the mobile device, the object:
identifies a landing page associated with the selected advertisement link displayed in the mobile device,
identifies an online form in the identified landing page, the online form including at least one entry field,
extracts, from the mobile device, data associated with the user and/or the mobile device for use in filling out the at least one of entry field of the landing page, and
utilizes the data extracted from the mobile device to pre-populate the at least one entry field of the landing page; and
displaying, by the mobile device, the landing page to the user of the mobile device, wherein the online form of the landing page is pre-populated using the information extracted from the user's mobile device.

2. The computer-implemented method of claim 1, wherein the configuration of the object can be modified to disable pre-populating a given online form, and wherein the modification of the configuration can be performed by one or more of:
a given user of the mobile device;
a developer of the mobile application; or
a provider of the preconfigured object.

3. The computer-implemented method of claim 1, wherein the advertisement link is displayed as a digital image with an embedded hyperlink associated with the landing page.

4. The computer-implemented method of claim 1, wherein the advertisement link is associated with an advertisement, and wherein the landing page displays information associated with the advertisement.

5. The computer-implemented method of claim 1, wherein the advertisement link displayed via the mobile device includes:
textual advertisement placed in a notification tray of the mobile device;
icons with embedded an advertisement link placed in a desktop of the mobile device; or
digital image with an embedded advertisement link placed during the running of the mobile application.

6. The computer-implemented method of claim 1, wherein prior to dynamically extracting data associated with the user and/or the given mobile device from the given mobile device, the method further comprises:
requesting, by the mobile device, the user of the mobile device, permission to access the mobile device for extracting the data associated with the user and/or the given mobile device.

7. The computer-implemented method of claim 6 wherein requesting the user permission includes requesting one or more of:
a permission to access system-level information associated with the given mobile device;
a permission to access personal identification information associated with the user that is stored in the mobile device;
a permission to access financial information associated with the user that is stored in the mobile device; or
a permission to access information related to social contacts associated with the user as is stored in the mobile device.

8. The computer-implemented method for pre-populating an online form as recited in claim 1, the method further comprising:
storing, by the mobile device executing the preconfigured object, the data gathered for the one or more identified fields in a user account associated with the user of the mobile device.

9. The computer-implemented method for pre-populating an online form as recited in claim 8, the method further comprising:
utilizing, by the mobile device, the stored data to pre-populate a one or more identified fields in a second identified online form present in a second identified landing page, wherein the second identified landing page is associated with a second presented advertisement link, wherein the second presented advertisement link is opened at a later time after the opening of the first presented advertisement link.

10. The computer-implemented method for pre-populating an online form as recited in claim 8, the method further comprising:
purging, by the mobile device, the extracted data subsequent to one or more of:
receiving a request from a user to delete the information;
subsequent to a specified duration of time;
subsequent to usage of the extracted information in a specified number of landing pages; or
subsequent to usage of the extracted information at the landing page.

11. The computer-implemented method of claim 6, wherein request, by the mobile device, for permission of the user of the mobile device to gather data for the one or more identified fields further comprises:
providing, by the mobile device, the user with a list of one or more identified fields which the mobile device identified to gather data for; and
receiving, by the mobile device, a selection of one or more identified fields from the list by the user, wherein the selection of one or more identified fields by the user provides the mobile device permission of the user to gather data for the selected fields.

12. The computer-implemented method of claim 11, wherein providing the user with a list of one or more identified fields includes providing the user with an interface to select the one or more identified fields.

13. The computer-implemented method of claim 12, wherein the interface, provided to the user, by the mobile device, categorizes the one or more identified fields into one or more subcategories of information, wherein a selection of one or more subcategories of information by the user automatically selects all of the one or more identified fields associated with each of the selected subcategories of information.

14. The computer-implemented method of claim 13, wherein the sub categories of information includes one or more of:
a financial information of user;
a contact information of user; or
an identity information of user.

15. A computer-implemented method for pre-populating an online form, the method comprising:
receiving, by computing server, an indication, from a user of a given computing device, of a user desire to access a first link included in a first webpage displayed to the user via the given computing device;
identifying, by the computing server, a landing page associated with the first link identified by the user;
identifying, by the computing server, presence of one or more fields in the landing page configured to receive data entered by the user;
dynamically extracting, by the computing server, data associated with the user and/or the given computing device from the given computing device;
receiving, by the computing server, an indication of display of the landing page associated with the first link at the given computing device; and
utilizing the data extracted from the given computing device, pre-populating, by the computing server, at least one of the one or more identified fields in the landing page displayed at the given computing device.

16. The computer-implemented method of claim 15, wherein the first link is displayed as a digital image with an embedded hyperlink associated with the landing page.

17. The computer-implemented method of claim 15, wherein dynamically extracting, by the computing server, data associated with the user and/or the given computing device from the given computing device includes one or more of:
querying an operating system associated with the given computing device;
direct API calls to the given computing device; or
analyzing logs files associated with the user and/or the given computing device present on the given computing device.

18. The computer-implemented method of claim 15, wherein prior to dynamically extracting data associated with the user and/or the given computing device from the given computing device, the method further comprises:
requesting, by the computing server, from the user of the computing device, permission to access the computing device for extracting the data associated with the user and/or the given computing device.

19. The computer-implemented method of claim 4, wherein requesting the user permission includes requesting one or more of:
a permission to access system-level information associated with the given computing device;
a permission to access personal identification information associated with the user that is stored in the computing device;
a permission to access financial information associated with the user that is stored in the computing device; or
a permission to access information related to social contacts associated with the user as is stored in the computing device.

20. The computer-implemented method for pre-populating an online form as recited in claim 15, the method further comprising:
storing, by the computing server, the data gathered for the one or more identified fields in a user account associated with the user of the computing device.

21. The computer-implemented method for pre-populating an online form as recited in claim 20, the method further comprising:
utilizing, by the computing server, the stored data to pre-populate a one or more identified fields in a second online form present in a second landing page, wherein the second landing page is associated with a second advertisement link, wherein the second advertisement link is opened at a later time after the opening of the first advertisement link.

22. The computer-implemented method for pre-populating an online form as recited in claim 20, the method further comprising:
purging, by the computing server, the extracted data subsequent to one or more of:
receiving a request from a user to delete the information;
subsequent to a specified duration of time;
subsequent to usage of the extracted information in a specified number of landing pages; or
subsequent to usage of the extracted information at the landing page.

23. The computer-implemented method of claim 18, wherein requesting, by the computing server, for permission to access the given computing device further comprises:
providing, by the computing device, the user with a list of one or more identified fields which the computing device identified to gather data for; and
receiving, by the computing device, a selection of one or more identified fields from the list by the user, wherein the selection of one or more identified fields by the user provides the computing device permission of the user to gather data for the selected fields.

24. The computer-implemented method of claim 23, wherein providing the user with a list of one or more identified fields includes providing the user with an interface to select the one or more identified fields.

25. The computer-implemented method of claim 24, wherein the interface, provided to the user, by the computing device, categorizes the one or more identified fields into one or more subcategories of information, wherein a selection of one or more subcategories of information by the user automatically selects all of the one or more identified fields associated with each of the selected subcategories of information.

26. The computer-implemented method of claim 26, wherein the sub categories of information includes one or more of:
a financial information of user;
a contact information of user; or
an identity information of user.

27. A system for pre-populating an online form, the system comprising:
a receiving module for receiving an indication from a user of a given computing device of a user desire to access a first link included in a first webpage displayed to the user via the given computing device;
an advertisement module for identifying a landing page associated with the first link identified by the user;
an advertisement module for identifying presence of one or more fields in the landing page configured to receive data entered by the user;
a user information retrieval module for dynamically extracting data associated with the user and/or the given computing device from the given computing device;
an advertisement module for receiving an indication of display of the landing page associated with the first link at the given computing device; and
a pre-population module for utilizing the data extracted from the given computing device for pre-populating at least one of the one or more identified fields in the landing page displayed at the given computing device.

28. The system of claim 27, wherein the first link is displayed as a digital image with an embedded hyperlink associated with the landing page.

29. The system of claim 27, wherein the first link is associated with an advertisement, and wherein the landing page displays information associated with the advertisement.

30. The system of claim 27, wherein prior to dynamically extracting data associated with the user and/or the given computing device from the given computing device, the system further comprises:
an acceptance module for requesting from the user of the computing device permission to access the computing device for extracting the data associated with the user and/or the given computing device.

31. The system of claim 30, wherein requesting the user permission includes requesting one or more of:
a permission to access system-level information associated with the given computing device;
a permission to access personal identification information associated with the user that is stored in the computing device;
a permission to access financial information associated with the user that is stored in the computing device; or
a permission to access information related to social contacts associated with the user as is stored in the computing device.

32. The system for pre-populating an online form as recited in claim 27, the system is further configured to:
store the data gathered for the one or more identified fields in a user account associated with the user of the computing device.

33. The system for pre-populating an online form as recited in claim 32, the system further configured to:
utilize the stored data to pre-populate a one or more identified fields in a second online form present in a second landing page, wherein the second landing page is associated with a second advertisement link, wherein the second advertisement link is opened at a later time after the opening of the advertisement link.

34. The system for pre-populating an online form as recited in claim 33, the system further comprising:
an acceptance module for purging the extracted data subsequent to one or more of:
receiving a request from a user to delete the information;
subsequent to a specified duration of time;
subsequent to usage of the extracted information in a specified number of landing pages; or
subsequent to usage of the extracted information at the landing page.

35. The system of claim 30, wherein the acceptance module for requesting permission to access the user's computing device is further configure to:
provide the user with a list of one or more identified fields which the computing device identified to gather data for; and
receive a selection of one or more identified fields from the list by the user, wherein the selection of one or more identified fields by the user provides the computing device permission of the user to gather data for the selected fields.

36. The system of claim 35, wherein providing the user with a list of one or more identified fields includes providing the user with an interface to select the one or more identified fields.

37. The system of claim 36, wherein the interface, provided to the user, by the computing device, categorizes the one or more identified fields into one or more subcategories of information, wherein a selection of one or more subcategories of information by the user automatically selects all of the one or more identified fields associated with each of the selected subcategories of information.

38. The system of claim 37, wherein the sub categories of information includes one or more of:
a financial information of user;
a contact information of user; or
an identity information of user.

39. A system for pre-populating an online form opened in a mobile device with information from the mobile device, the system comprising:
a computing module for running a mobile application, wherein the mobile application includes a preconfigured object that is executed when the mobile application is run on the mobile device;
upon receiving, by the system, a selection, by the user, of an advertisement link displayed in the mobile device, the object executed by the computing module:
identifies a landing page associated with the selected advertisement link displayed in the mobile device,
identifies an online form in the identified landing page, the online form including at least one entry field,
extracts, from the mobile device, data associated with the user and/or the mobile device for use in filling out the at least one of entry field of the landing page, and
utilizes the data extracted from the mobile device, pre-populating the at least one entry field of the landing page; and
a pre-population module for displaying the landing page to the user of the mobile device, wherein the online form of the landing page is pre-populated using the information extracted from the given mobile device.

40. The system of claim 39, wherein the configuration of the object can be modified to disable pre-populating a given online form, and wherein the modification of the configuration can be performed by one or more of:
a given user of the mobile device;
a developer of the mobile application; or
a provider of the preconfigured object.

41. The system of claim 39, wherein the advertisement link is displayed as a digital image with an embedded hyperlink associated with the landing page.

42. The system of claim 39, wherein the advertisement link is associated with an advertisement, and wherein the landing page displays information associated with the advertisement.

43. The system of claim 39, wherein the advertisement link displayed via the mobile device includes:
textual advertisement placed in a notification tray of the mobile device;
icons with embedded an advertisement link placed in a desktop of the mobile device; or
digital image with an embedded advertisement link placed during the running of the mobile application.

44. The system of claim 39, wherein prior to dynamically extracting data associated with the user and/or the given mobile device from the given mobile device, the system further comprises:
an acceptance module for requesting the user of the mobile device permission to access the mobile device for extracting the data associated with the user and/or the given mobile device.

45. The system of claim 44, wherein requesting the given permission includes requesting one or more of:
a permission to access system-level information associated with the given mobile device;
a permission to access personal identification information associated with the user that is stored in the mobile device;
a permission to access financial information associated with the user that is stored in the mobile device; or
a permission to access information related to social contacts associated with the user as is stored in the mobile device.

46. The system for pre-populating an online form as recited in claim 39, the system further configured to:
store the data gathered for the one or more identified fields in a user account associated with the user of the mobile device.

47. The system for pre-populating an online form as recited in claim 46, the system further configured to:
utilize the stored data to pre-populate a one or more identified fields in a second identified online form present in a second identified landing page, wherein the second identified landing page is associated with a second presented advertisement link, wherein the second presented advertisement link is opened at a later time after the opening of the first presented advertisement link.

48. The system for pre-populating an online form as recited in claim 46, the system further configured to:
purge the extracted data subsequent to one or more of:
receiving a request from a user to delete the information;
subsequent to a specified duration of time;
subsequent to usage of the extracted information in a specified number of landing pages; or
subsequent to usage of the extracted information at the landing page.

49. The system of claim 44, wherein request for permission of the user of the mobile device to gather data for the one or more identified fields further comprises:
providing the user with a list of one or more identified fields which the mobile device identified to gather data for; and
receiving a selection of one or more identified fields from the list by the user, wherein the selection of one or more identified fields by the user provides the mobile device permission of the user to gather data for the selected fields.

50. The system of claim 49, wherein providing the user with a list of one or more identified fields includes providing the user with an interface to select the one or more identified fields.

51. The system of claim 50, wherein the interface, provided to the user categorizes the one or more identified fields into one or more subcategories of information, wherein a selection of one or more subcategories of information by the user automatically selects all of the one or more identified fields associated with each of the selected subcategories of information.

52. The system of claim 51, wherein the sub categories of information includes one or more of:
a financial information of user;
a contact information of user; or
an identity information of user.

53. A system for pre-populating an online form opened in a mobile device with information from the mobile device, the system comprising:
a means for running a mobile application, wherein the mobile application includes a preconfigured object that is executed when the mobile application is run on the mobile device;
upon receiving, by a means, a selection, by the user, of an advertisement link displayed in the mobile device, a means for executing the object, wherein the executed object includes:
a means for identifying a landing page associated with the selected advertisement link displayed in the mobile device,
a means for identifying an online form in the identified landing page, the online form including at least one entry field,
a means for extracting from the mobile device, data associated with the user and/or the mobile device for use in filling out the at least one of entry field of the landing page, and
a means for utilizing the data extracted from the mobile device to pre-populate the at least one entry field of the landing page; and
a means for displaying the landing page to the user of the mobile device, wherein the online form of the landing page is pre-populated using the information extracted from the user's mobile device.

54. The system of claim 53, wherein the system comprises a means for modifying the configuration of the object, wherein the configuration of the object can be modified to disable pre-populating a given online form, and wherein the means for modification of the configuration can be one or more of:
a given user of the mobile device;
a developer of the mobile application; or
a provider of the preconfigured object.

55. The system of claim 53, wherein the system comprises a means for displaying an advertisement link, and wherein the advertisement link can be displayed as a digital image with an embedded hyperlink associated with the landing page.

56. The system of claim 53, wherein the advertisement link is associated with an advertisement, wherein the system comprises a means for displaying the landing page, and wherein the landing page displays information associated with the advertisement.

57. The system of claim 53, wherein the system comprises a means for displaying the advertisement link, and wherein the advertisement link displayed includes:
textual advertisement placed in a notification tray of the mobile device;
icons with embedded an advertisement link placed in a desktop of the mobile device; or
digital image with an embedded advertisement link placed during the running of the mobile application.
